(19) United States
(12) Patent Application Publication
(10) Pub. No.: US 2023/0246857 A1
(43) Pub. Date: Aug. 3, 2023

(54) VIDEO MESSAGING

(71) Applicant: Zoom Video Communications, Inc., San Jose, CA (US)

(72) Inventors: Cecile Boucheron, Brooklyn, NY (US); Ganna Isayeva, Odessa, FL (US); Youjin Jang, San Ramon, CA (US); Sharvari Nerurkar, Redmond, WA (US); Archil Vardidze, Austin, TX (US)

(21) Appl. No.: 17/588,798

(22) Filed: Jan. 31, 2022

(51) Int. Cl. H04L 12/18; H04L 65/1101; H04L 51/04; H04L 51/10

(52) U.S. Cl. CPC H04L 12/1813; H04L 29/06027; H04L 51/04; H04L 51/10

(57) ABSTRACT

A system is disclosed, the system including a non-transitory computer-readable medium, a communications interface, and a processor. The processor may be configured to execute processor executable instructions stored in the non-transitory computer-readable medium. The processor may join a chat channel, where the chat channel may be established by a chat and video conference provider and configured to enable one or more users to exchange messages using respective client devices. The processor may receive an input corresponding to a request to record a video message. The processor may generate a video message recording platform for generating the video message. The processor may transmit, to a chat and video conference provider, the video message generated on the video message recording platform. The processor may receive, from the chat and video conference provider via the chat channel, an indication that the video message may be posted in the chat channel.

### BACKGROUND OF THE INVENTION

The present application relates generally to chat channels and various functions therein, and more particularly providing a video message within a chat channel.

### BRIEF DESCRIPTION OF THE DRAWINGS

FIG. 1 shows an example system 100 that provides videoconferencing and chat functionality including video messaging to various client devices, according to certain examples.

FIG. 2 shows an example system in which a chat and video conferences provider provides chat and videoconferencing functionality to various client devices, according to certain examples.

FIG. 3 shows a master chat panel, according to certain examples.

FIG. 4 shows a master chat panel with a menu, according to certain examples.

FIG. 5 shows a master chat panel including a video message input window, according to certain examples.

FIG. 6 shows a master chat panel with a video message editing window, according to certain examples.

FIG. 7 shows a master chat panel with a video message in a chat channel, according to certain examples

FIG. 8 shows a method of providing a video message within a chat channel, according to certain examples.

FIG. 9 shows an example computing device suitable for use in example systems or methods for providing a video message in a chat channel, according to certain examples.

### DETAILED DESCRIPTION OF THE INVENTION

Examples are described herein in the context of video messaging. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another

Platforms capable of allowing participants to send messages between each other continue to grow in popularity. Companies have dedicated platforms that allow participants to send and receive messages, or chat, with other participants to increase productivity and communication, as well as provide for social interaction. Schools and universities may use similar platforms for similar purposes. Some platforms may be used purely socially, or for gaming, or some other purpose; chat platforms proliferate modern interaction.

A chat platform may provide multiple chat channels, which may be organized by groups of participants that may access the chat channel. For example, a company may have multiple teams working on different tasks. Each team may have its own associated chat channel. A participant may be a member of multiple chat channels, such as if the participant is a member of multiple teams, for example. While chats can provide quick communication between members of the chat channel, the quick, text-based style of most chat platforms may not be the most effective method of communication in all cases.

For example, a participant may wish to send a video message to one or more participants associated with the chat channel. A video message may be more appropriate where a more complicated concept is being conveyed, where the sender wants to be more personal, or when the participant would like to show an object to the other participants of the chat channel. Further, it may not be feasible or efficient to schedule a meeting to discuss the subject matter. Thus, sending a message may be a better action to take. These are just examples and are not meant to be limiting; there are any number of reasons a participant may need to send a video message. By providing video messages within a chat channel, communication may be improved between participants of the chat channel. Each member of the chat channel can review the video message at their leisure, or ignore it entirely if it does not pertain to them. Systems and methods disclosed herein may allow for video messages to be provided in a chat channel, and may thereby improve communication.

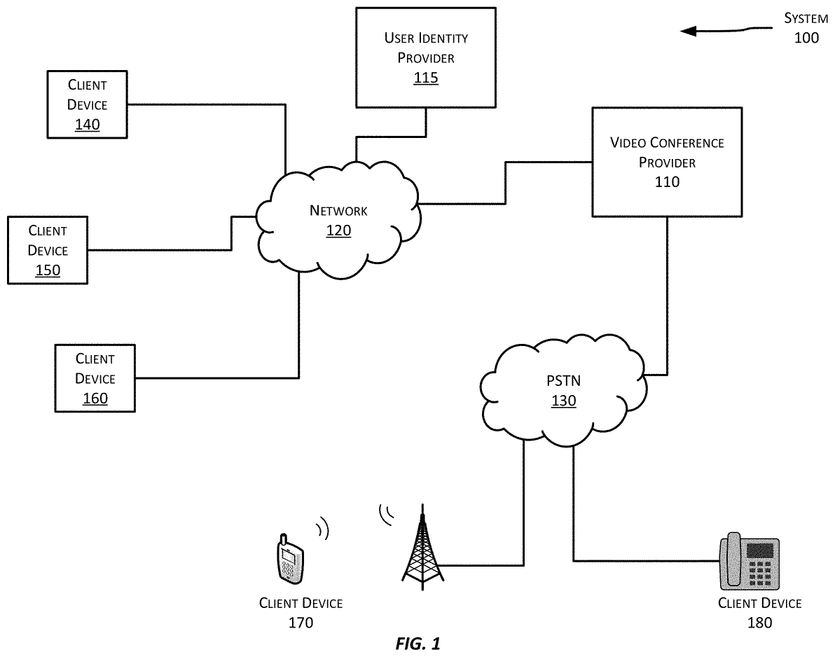

FIG. 1 shows an example system 100 that provides videoconferencing and chat functionality including video messaging to various client devices. The system 100 includes a chat and video conference provider 110 that is connected to multiple communication networks 120, PSTN 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the interne, so it may be accessed by anyone. Some examples may even provide a hybrid model in which a chat and video conference provider 110 may supply components to enable a private organization to host private internal video conferences or to connect its system to the chat and video conference provider 110 over a public network.

It should be understood that in example examples, the chat and video conference provider 110 may be a chat provider 110 providing only a chat functionality, while in other example examples, the chat and video conference provider 110 may be a video conference provider 110 providing only video conferencing functionality. Furthermore, although the chat and video conference provider 110 are shown as one entity, other configurations are considered. For example, a chat provider may have a structure similar to that of chat and video conference provider 110, and a video conference provider may also have a structure similar to the chat and video conference provider 110. The chat provider and the video conference provider may be connected through the same network (e.g., the network 120), or may be operable to communicate with each other through another shared network.

The system optionally also includes one or more user identity providers, e.g., user identity provider 115, which can provide user identity services to users of the client devices 140-160 and may authenticate user identities of one or more users to the chat and video conference provider 110. In this example, the user identity provider 115 is operated by a different entity than the chat and video conference provider 110, though in some examples, they may be the same entity.

In some examples, the chat and video conference provider 110 may provide a chat functionality. In such examples, the chat and video conference provider 110 may allow a user to create one or more chat channels where the user may exchange messages with other users that have access to the chat channel(s). The messages may include text, image files, video files, or other files. In some examples, a chat channel may be “open,” meaning that any user may access the chat channel. In other examples, the chat channel may require that a user be granted permission to access the chat channel. The chat and video conference provider 110 may provide permission to a user and/or an owner of the chat channel may provide permission to the user. Furthermore, there may be any number of users permitted in the chat channel.

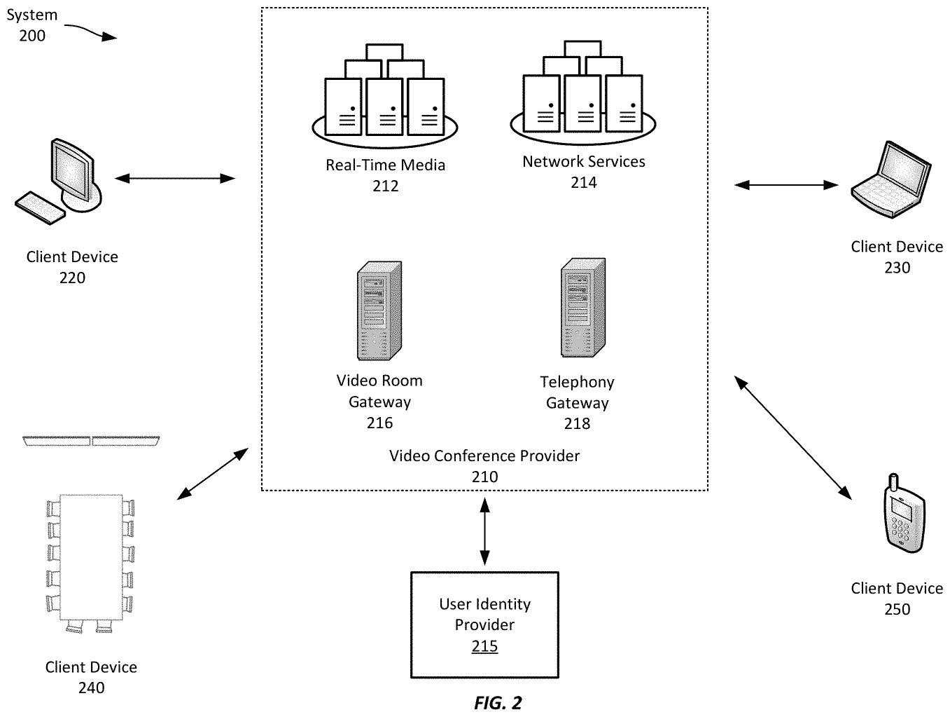

The chat and video conference provider 110 may also provide video conferencing functionality. For example, the chat and video conference provider 110 may allow clients to create videoconference meetings (or “meetings”) and invite others to participate in those meetings as well as perform other related functionality, such as recording the meetings, generating transcripts from meeting audio, manage user functionality in the meetings, enable text messaging during the meetings, etc. FIG. 2, described below, provides a more detailed description of the architecture and functionality of the chat and video conference provider 110.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

Chat channels may be provided by the chat and video conference provider 110 to which participants are connected. Similar to the meetings discussed above, the chat channels are constructs provided by a server where the messages are received then directed to the various participants. The messages may include text, audio files, video files, image files, or any other electronic file type.

To create a meeting with the chat and video conference provider 110, a user may contact the chat and video conference provider 110 using a client device 140-180 and select an option to create a new meeting. Such an option may be provided in a webpage accessed by a client device 140-160 or client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The chat and video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating the that meeting has not yet started or the host may be required to specifically admit one or more of the users.

During the meeting, the participants may employ their client devices 140-180 to capture audio or video information and stream that information to the chat and video conference provider 110. They also receive audio or video information from the chat and video conference provider 210, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting and they will no longer receive audio or video streams for the meeting (and will stop transmitting audio or video streams). The chat and video conference provider 110 may also invalidate the meeting information, such as the meeting identifier or password/passcode.

The chat and video conference provider 110 may use a similar process as is used to create a meeting to create a chat channel. A user may contact the chat and video conference provider 110 using a client device 140-180 and select an option to create a chat channel. Such an option may be provided in a webpage accessed by a client device 140-160 or client application executed by a client device 140-160. To create the chat channel, the chat and video conference provider 110 may prompt the user for certain information, a number of participants, a type of encryption to use, whether the chat channel is confidential or open to anyone, a title or subject, etc. After receiving the various chat channel settings, the chat and video conference provider may create a record for the chat channel and generate a chat identifier to one or more user invited to the chat channel. In some examples, the certain information associated with the chat channel may be automatically generated by the chat and video conference provider 110.

To provide such functionality, one or more client devices 140-180 may communicate with the chat and video conference provider 110 using one or more communication networks, such as network 120 or the PSTN 130. The client devices 140-180 may be any suitable computing or communications device that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any LAN, MAN, WAN, cellular network (e.g., 3G, 4G, 4G LTE, 5G, etc.), or any combination of these. Other types of computing devices may be used instead or as well, such as tablets and/or smartphones.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and is not limited solely to dedicated telephony devices like conventional telephones.

Referring again to client devices 140-160, these client devices 140-160 contact the chat and video conference provider 110 using network 120 and may provide information to the chat and video conference provider 110 to access functionality provided by the chat and video conference provider 110, such as access to create new meetings/chat channels or join existing meetings/chat channels. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the chat and video conference provider 110.

A user identity provider 115 may be any entity trusted by the chat and video conference provider 110 that can help identify a user to the chat and video conference provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 115 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the chat and video conference provider 110.

When the user accesses the chat and video conference provider 110 using a client device, the chat and video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide user identification information to identify the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak or share content in a meeting or chat, hear or view certain content shared in the meeting, or access other meeting functionality.

It should be appreciated that users may choose to participate in meetings anonymously and decline to provide user identification information to the chat and video conference provider 110, even in cases where the user has an authenticated identity and employs a client device capable of identifying the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective chat and/or video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more user identity providers 215, which can authenticate various users to the chat and video conference provider 210 generally as described above with respect to FIG. 1.

In this example, the chat and video conference provider 210 employs multiple different servers (or groups of servers) to provide different examples of chat and/or video conference functionality, thereby enabling the various client devices to create and participate in chat channels and/or video conference meetings. The chat and video conference provider 210 uses one or more real-time media servers 212, one or more network services servers 214, one or more video room gateways 216, and one or more telephony gateways 218. Each of these servers 212-218 is connected to one or more communications networks to enable them to collectively provide access to and participation in one or more chat channels and/or video conference meetings to the client devices 220-250.

The real-time media servers 212 provide multiplexed multimedia streams to meeting participants, such as the client devices 220-250 shown in FIG. 2. While chat and/or video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various chat and/or video and audio streams based on the target client device and communicate multiplexed streams to each client device. For example, the real-time media servers 212 receive chat and/or audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the chat and/or audio and video using the client device's video and audio devices. In this example, the real-time media servers do not multiplex client device 220's own video and audio feeds when transmitting streams to it. Instead each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia streams in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local real-time media servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the chat and video conference provider 210 and across many different real-time media servers 212.

Turning to the network services servers 214, these network services servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting a user identity provider 215 to verify the provided credentials. Once the user's credentials have been accepted, the network services servers 214 may perform administrative functionality, like updating user account information, if the user has an identity with the chat and video conference provider 210, or scheduling a new meeting, by interacting with the network services servers 214.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

The chat and video conference provider 210 may use a similar process to that which is used to schedule a meeting (as described above) to create a chat channel. A user may contact the chat and video conference provider 210 using a client device 220 and select an option to create a chat channel. After receiving various chat channel settings (e.g. a title, a participant list, etc.), the chat and video conference provider may create a record for the chat channel and generate a chat identifier to invite one or more users to the chat channel. In some examples, the certain information associated with the chat channel may be automatically generated by the chat and video conference provider 210.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples, additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting and/or a chat channel, client devices will send and receive multimedia streams via the real-time media servers 212, but they may also communicate with the network services servers 214 as needed during meetings. For example, if the host leaves the meeting or chat channel, the network services server(s) 214 may appoint another user as the new meeting host and assign host administrative privileges to that user. Hosts may have administrative privileges to allow them to manage their chat channels and/or meetings, such as by enabling or disabling screen sharing, muting or removing users from the meeting, assigning or moving users to the chat channel or meeting, recording meetings, etc. Such functionality may be managed by the network services server(s) 214.

For example, if a host wishes to remove a user from a chat channel, they may identify the user and issue a command through a user interface on their client device. The command may be sent to a network services server 214, which may then disconnect the identified user from the corresponding real-time media server 212. If the host wishes to move one or more participants into a meeting or chat channel, such a command may also be handled by a network services server 214, which may provide authentication information to the one or more participants for joining the chat channel and then connect the one or more participants to the chat channel. In some examples, a chat channel may not have a host.

In addition to creating and administering on-going meetings, the network services server(s) 214 may also be responsible for closing and tearing-down meetings once they have completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request. Similar steps may be taken for ending a chat channel. For example, after receiving a command to terminate a chat channel, the network services server 214 communicate with the real time media server(s) 212 to stop a messaging service for the chat channel and remove any users from the chat channel records.

Depending on the functionality provided by the chat and video conference provider, the network services server(s) 214 may provide additional functionality, such as by providing private chat and meeting capabilities for organizations, special types of meetings (e.g., webinars), etc. Such functionality may be provided according to various examples of chat and video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive chat and/or video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosed by the chat and video conference provider 210. Because telephony devices communicate using the PSTN and not using computer networking protocols, such as TCP/IP, the telephony gateway servers 218 act as an interface that converts between the PSTN and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio signals to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server 218 is instead joined to the meeting on the telephony device's behalf.

After joining the meeting, the telephony gateway server 218 receives an audio stream from the telephony device and provides it to the corresponding real-time media server 212, and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some chat and video conference providers may provide more or less functionality than described above and may not separate functionality into different types of servers as discussed above. Instead, any suitable servers and network architectures may be used according to different examples.

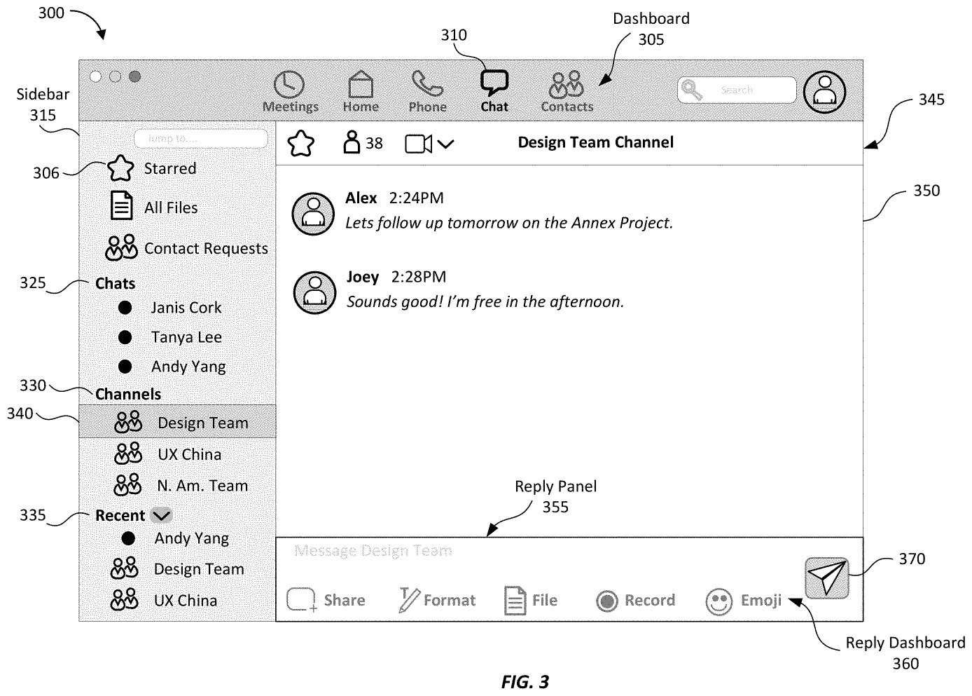

FIG. 3 shows a master chat panel 300 according to certain examples. The master chat panel 300 may be displayed on a client device in response to information sent by a chat and video conference provider, such as the chat and video conference provider 110 in FIG. 1. The master chat panel 300 may be generated by an application run by one or more processors stored on the client device. The client device may be a personal computer such as a desktop or laptop, a mobile device, or other computing device having at least a processor, non-transitory memory, a user input system, and communication interface, providing network connectivity.

The master chat panel 300 may include a general dashboard 305, a chat control dashboard 345, a sidebar 315, a chat window 350, a reply dashboard 360, and a reply panel 355. The general dashboard may include one or more buttons or links that switch functionalities and/or views of the master chat panel 300. For example, FIG. 3 shows a chat view, perhaps in response to a user command selecting a chat button 310 in the chat control dashboard 305. In this view, the chat window 350, the reply panel 355, and other components illustrated in FIG. 3 may be displayed on the client device. In other examples, a contacts button may be selected by a user. In response the contacts button being selected, the chat window 350, the reply dashboard 360 and the reply panel 355 may be replaced by a display a contacts window including a list of user contacts associated with the user of the client device. The sidebar 315 may be displayed alongside the contacts window. Other configurations are also possible. Various buttons on the chat control dashboard 305 may correspond to various displays of windows being displayed on the client device. Any number of components shown in FIG. 3 may be displayed on the client device with any of the various windows. Similarly, any of the components may cease to be displayed in accordance with any of the windows.

The sidebar 315 may include one or more chat channel headings. A chat heading 302a may include one or more chat channels such as the chat channel 304a. In some examples, the chat channel 304a may include a private chat, where the chat is between the user associated with the client device and another user. Messages sent and received via the chat channel 304a may only be accessed by the users in the chat channel 304a. Thus, the client devices associated with the user and the client device associated with the other user may securely communicate with each other.

A chat channel heading 302b may include a chat channel 304b. The chat channel 304b may by a group chat, where two or more users have access to send and receive messages within the chat channel. In some examples, the chat channel 304b may only be accessed by users who have permission to enter the chat channel. A host of the chat channel 304b and/or the chat and video conference provider may grant access to the chat channel 304b. Although only the chat channel headings 302a-b are shown, other chat channel headings are possible. For example, some examples may include a chat channel heading that displays, on the client device, only those channels that the user associated with the client device is a member of that have been recently accessed. “Recently accessed” may be determined by the client device to be a fixed number of most recent channels accessed by the user, or may be only those channels access within a certain time, calculated from the current time.

The sidebar 315 may also include one or more combinatory headings, such as starred combinatory heading 306. A combinatory heading may aggregate one or more messages from one or more chat channel, according a predetermined criterion. The combinatory headings may include a link that, in response to a user command, cause the client device to display one or more messages in the chat window 350. The messages may be gathered from one or more chat channels, such as the chat channel 304a-b, and displayed based on predetermined criteria. In FIG. 3, for example, the starred combinatory heading 306 may gather only those messages that have been marked by a user of the client device. The marked messages may be stored at the client device, and/or may be stored at the chat and video conference provider. The link may cause the one or more processors included on the client device to determine which messages are marked messages and cause them to be displayed in the chat window 350. In some examples, the link may cause the client device to send a signal to the chat and video conference provider. The chat and video conference provider may then determine which messages are marked messages and send information to the client device to generate a display of the marked messages in the chat window 350.

Other combinatory headings (and associated links and functionality) are also considered. Other examples may include an unread heading, an all files heading, a contact request heading, and others. As with the starred combinatory heading 306, an associated link may cause the client device and/or the chat and video conference provider to determine which messages (if any) meet predetermined criteria associated with the combinatory heading and subsequently display those messages on the client device.

The chat control dashboard 345 may display one or more control buttons and/or information regarding the chat channel currently being displayed on the client device. The control buttons may include links that mark a message (e.g. to mark it such that it is determined to be a marked message via the starred combinatory heading 306), begin a video conference, schedule a meeting, create a video message, or other tasks. The chat control dashboard may also include a title of the chat channel currently being displayed on the client device and/or a number of users with access to the chat channel. One of ordinary skill in the art would recognize many different possibilities and configurations.

The reply panel 355 may include an input field, where the user may cause the client device to send a message to the chat channel. The input field may be accessed by a peripheral device such as a mouse, a keyboard, a stylus, or any other suitable input method. In some examples, the input field may be accessed by a touchscreen or other system built into the client device. In some examples, a notification may be sent from the client device and/or the video conference provider that indicates a response is being entered in to the input field by the user. In other examples, no notification may be sent.

The reply dashboard 360 may include one or more buttons that, in response to a user command edit or modify a response input into the input field. For example, a record button may be provided, that allows the client device to capture audio and video. In other examples, there may be a share button that causes the client device to send the message to a different chat channel. In yet another example, there may be a reaction button which causes an image to be sent by the client device to the chat channel in response to a message posted in the chat channel.

In some examples, there may be one or more formatting buttons included on the reply dashboard 360. The one or more formatting buttons may change the appearance of a replay entered in the input field. The user may thereby edit and customize their response in the input field before sending.

The reply dashboard 360 may include a send button 370. The send button 370 may, in response to a user command, cause the client device to send the contents of the input field (or “response”) to the chat channel. The client device may then send the response to the chat and video conference provider. The chat and video conference provider may then send the response to the chat channel, which publishes the response for the users in the channel. The response may include image files such as JPEG, PNG, TIFF, or files in any other suitable format. The response may also include video files such as MPEG, GIF, or video files in any other suitable format. The response may also include text entered into the input field and/or other files attached to the message such as a PDF, DOC, or other file format.

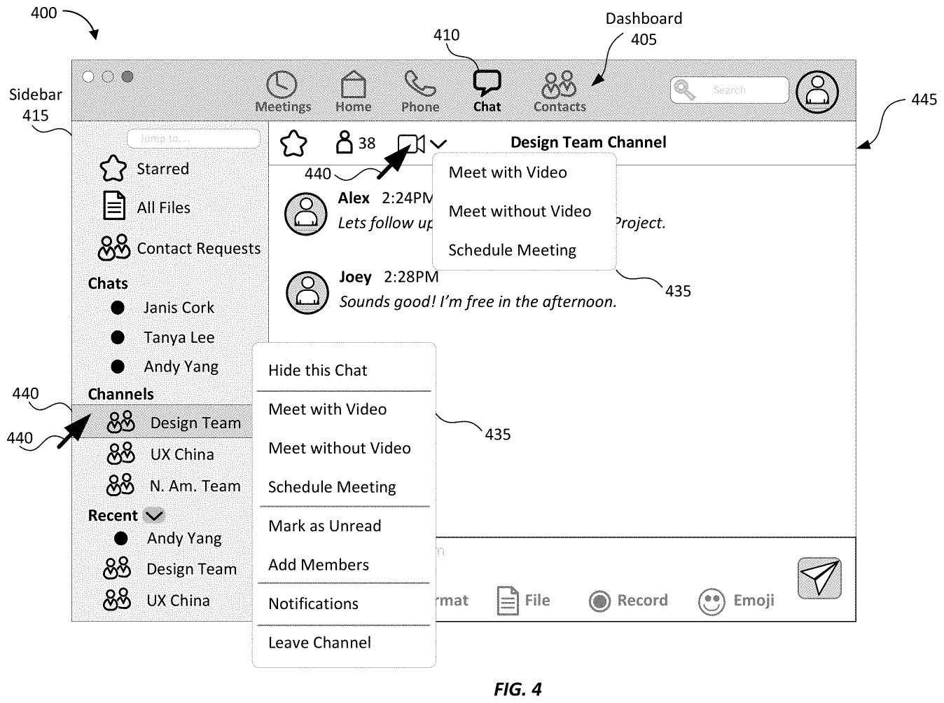

FIG. 4 shows a master chat panel 400 with a menu, according to certain examples. The master chat panel 400 may be similar to the master chat panel 300. Thus, even where not specified, the master chat panel 400 may include at least those components and functionalities described in relation to FIG. 3.

The master chat panel 400 may include menus 435. The menu 435 may include one or more buttons, which add functionality to the messages in the chat channels and/or the chat channels themselves. The menu 435 may be displayed in response to a user request on the client device. In the illustrated example, the user may have requested the menu 435 associated with a design team chat channel 404. The user may have requested the menu 435 from the client device using the cursor 440. In some examples, mousing over a channel may cause the menu 435 to be displayed. In other examples, the menu 435 may be displayed in response to another user input (e.g., a right-click on the mouse while hovering over the design team chat channel 404). In other examples, the menu 435 may be displayed by a user input occurring in another space rather than the design team chat channel 404. For example, the menu 435 may be brought up by an input in a blank space of a chat window 450. One of ordinary skill in the art would recognize many different possibilities.

The menu 435 may include options associated with a chat channel. Those options may include starting a video conference (or “meeting”), scheduling a meeting, adding or removing members from the chat channel, changing setting associated with notifications sent to the client device, no longer displaying the chat channel in sidebar 415, recording a video message, and other such options. In some examples, the menu 435 may include options for a specific chat within the chat channel. For example, the menu 435 may include an option to mark a message as unread.

Although the menu 435 is illustrated as being opened from the design team chat channel 404 on the sidebar 415, the menu 435 may be opened from elsewhere. The menu 435 may display the same functions or different functions depending on where it is opened. For example, there may be a button on the chat control dashboard 445 that causes the client device to open the menu 435. Opening the menu 435 from the chat control dashboard 445 may only display functions related to a video meeting, for example. Functions related to a specific message in the chat may only be displayed in the menu 435 if the client device receives a user input on the specific message.

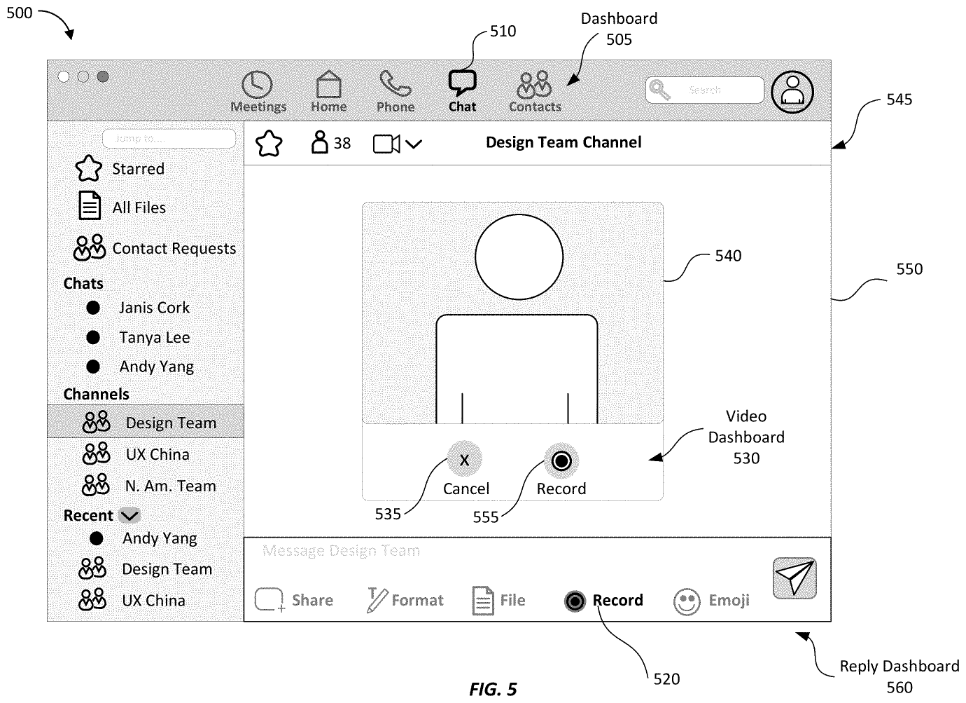

FIG. 5 shows a master chat panel 500 including a video message input window, according to certain examples. The master chat panel 500 may include a general dashboard 505, a chat control dashboard 545, and a reply dashboard 560. The master chat panel 500 may be similar to the master chat panel 300 in FIG. 3, and therefore have some or all of components of the master chat panel 300, even if not pictured in FIG. 5.

The general dashboard 505 may indicate a display window on the client device. For example, in FIG. 5, the selected display window may be “chat” 510 and thus a chat window 550 may be displayed on the client device. The chat control dashboard 545 may include information such as a name of a chat channel currently being displayed on the client device, a number of participants currently using the chat channel, and other information regarding the chat channel.

The reply dashboard 560 may include a record button 520. In response to a user input corresponding to the record button 520, the client device may send a request to the chat and video conference provider to record a video message. The chat and video conference provider may then provide a video message recording platform to the client device via the chat channel. The video message recording platform may include information to generate a video message input window 540.

In response to receiving the video message recording platform, the client device may detect audio and/or video recording devices included in, or in communication with, the client device. For example, the client device may be a mobile device with an on-board microphone and an on-board camera. The client device may detect that the on-board microphone and on-board camera are available for use and then generate the video message input window 540. The client device may then access video being captured by the on-board camera and display the video in the video message input window 540.

In another example, the client device may be a computing device such as a desktop computer. In response to a user input corresponding to the record button 520, the client device may detect audio and/or video recording devices such as an external microphone and webcam. Similar to the example of a mobile device, the client device here may display the video from the webcam in the video message input window 540. In some examples, the client device may not detect an audio and/or video recording device. The master chat panel 500 may then display an error message, or display the video message input window 540 without any video. The examples discussed above are not limiting; many different types of client devices could be used. One of ordinary skill in the art would instantly recognize many different possibilities.

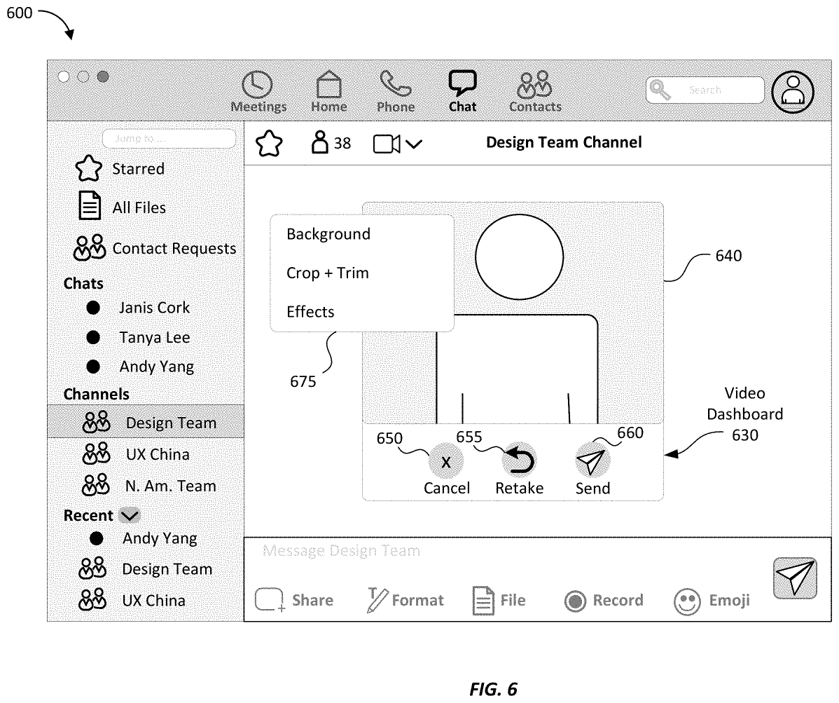

In some embodiments, the client device may generate a pre-editing menu before or simultaneously with the video input window 545. The pre-editing window appear as the menu 435 in FIG. 4 but with additional options. The pre-editing window may not include all the options included in the menu 435. The pre-editing window may be similar to the editing window 675, as described below. Thus, the pre-editing window may include functions such as a background function, a crop function, a trim function, one or more effect functions, and any other similar video editing feature. Details of these functions are provided below in relation to FIG. 6. In some embodiments, the pre-editing menu may include functions to change audio and video setting (e.g., changing an input volume of a microphone (including disabling sound altogether), mirroring video input from a camera, etc.)

The video message input window 540 may be configured to cause the client device to record audio and video data. The video message input window 540 may include a video dashboard 530. The video dashboard may in turn include a cancel button 535 and a message record button 555. In response to the a user input corresponding to the cancel button 535, the client device may cause the video message input window 540 to be closed and display a previous window. For example, if the user associated with the client device input the record button 520 in error, the user may close the video message input window without any data being recorded or stored, and the chat window 450 from FIG. 4 may be displayed.

In response to a first user command associated with the message record button 555, the client device may begin to capture audio and video data from the camera and the microphone. The video message input window may continue to display video data from the client device while recording the audio and video data. The client device may stop capturing the audio and video data in response to a second user command associated with the message record button 555. The client device may store the audio and video data as a video message in a memory device included in the client device. In some examples, the video message may be limited to a predetermined time period (e.g., 3 minutes). The video message may also be limited to a predetermined file size (e.g., 4 MB).

In some examples, the video message input window 540 may include a screen share function. The screen share function may be displayed as a button in addition to or in place of the message record button 555. In response to a first user input correlated with the message record button 555, the client device may capture video data associated with a display of the client device. The client device, in response to a user input, may capture video data associated with a full display of the client device, an application displayed on the client device, and any other such display. The video message input window 540 may display the video data as it is being captured. Audio data may be recorded from a microphone, allowing the user to speak while recording their screen. The client device may stop capturing the audio and video data in response to a second user command associated with the message record button 555. The captured audio and video data may then be stored as a video message in a memory device included in the client device. In some examples, the video message may be limited to a predetermined time period (e.g., 10 minutes). The video message may also be limited to a predetermined file size (e.g., 30 MB).

In some examples, the screen share function may be provided to enable a demo within the video message that includes other a video data associated with a display of the client device to the chat channel. The video data may include a full screen displayed on the user device, an application window displayed on the user device, or any other such display. The permission may be granted from an admin window, accessible only to certain participants of the chat channel. The demo may also include a pre-editing window, such that various functions may be applied to the demo prior to providing the demo to the chat channel. The functions of the pre-editing window may include functions to change audio and video setting (e.g., changing an input volume of a microphone (including disabling sound altogether), mirroring video input from a camera, etc., a background function, a crop function, a trim function, one or more effect functions, and any other similar video editing feature. These functions are described on more detail in relation to FIG. 6.

FIG. 6 shows a master chat panel 600 with a video message editing window, according to certain examples. The master chat panel 600 may be similar to the master chat panel 500 in FIG. 5. Therefore, the master chat panel 600 may include some or all of components and functionalities of the master chat panel 500.

The master chat panel 600 may include a video message editing window 640. The video message editing window 640 may be generated by the client device after a video message is recorded and saved. The video message editing window 640 may include a video dashboard 630 that may include a cancel button 650, a retake button 655, and a send button 660. The video message editing window 640 may continue to display video data from the client device, or may display a frame of the video message. In response to the a user input corresponding to the cancel button 650, the client device may cause the video message editing window 640 to be closed and display a previous window, such as the chat window 350 in FIG. 3.

In some examples, the user may preview the video message by providing an input on the video message editing window 640. For example, the user may click a mouse (or other device connected to the client device) on the frame of the video message displayed in the video message editing window 640. The client device may then cause the video message to be played back in the video message editing window 640. In this way, the user may preview the video message prior to posting the video message to the chat channel.

In response to the a user input corresponding to the retake button 655, the client device may discard the video message, erasing it from the memory device. The client device may then cause a new video message input window, such as the video message input window 540 in FIG. 5, to be generated and displayed in the master chat panel 600. Thus, if the user was unsatisfied with the video message, the user may record a new video message.

The video message editing window 640 may include an editing menu 675. The editing menu 675 may be generated in response to a user input (e.g., a right-click on the image displayed in the video message editing window 640), or there may be a button (not pictured) included on the video dashboard 630 that opens the editing menu 675. The editing menu 675 may include video editing features such as a background function, a crop function, a trim function, one or more effect functions, an edit or disable sound function, an annotation function (e.g., annotating a screen share), and any other similar video editing feature. The user may thereby edit the video message prior to posting in the chat channel.

For example, the user may select a background function. In response, the client device may access one or more backgrounds stored on the client device. After the user selects a background, the video message editing window 640 may then display the video message utilizing the background in place of a portion of the video message, such as the background in the video behind the user's head and torso. The client device may then update the video message to include the background. The background may be provided by the chat and video conference provider and/or stored on the client device. The background may include image files, video files, or a background effect such as a blurring effect.

In another example, the user may select a crop function. The client device may then display one or more lines over the frame of the video message displayed in the video message editing window 640. The user may cause the lines to move across the frame of the video message. The user may then accept the placement of the lines. In response, the client device may update the video message to only include the portion of the video message encompassed by the lines.

In yet another example, the user may select an effect function. The client device may then access one or more effects, including a color shift, one or more animation overlays, or other similar video effects. After the user selects one or more effects, the client device may update the video message to include the effects. The editing functions described above are merely examples; other editing capabilities are possible. For example, the user may remove a segment of the video message based on time or other criteria. One of ordinary skill in the art would recognize many different possibilities.

In some examples, the video message may include a demo captured within an application window rather than (or in addition to) video captured by a camera, as described above. The user may select a presentation mode for the video message including a screen share. The presentation may be a picture-in-picture mode, enabling participants in the chat channel to view the demo as an overlay. The overlay may be displayed in the chat channel window or may be displayed in a video conference.

In response to a user input corresponding to the send button 660, the chat and video conference provider may receive the video message transmitted by the client device, using systems such as those disclosed in FIG. 1 and FIG. 2. The client device may store the video message in the memory device after transmitting the video message to the chat and video conference provider, or the client device may delete the video message. In some examples, transmitting the video message may cause the client device and/or the chat and video conference provider to transcribe the video message. The transcription may include a speech recognition generated file created from one or more audio files included in the video message. The transcription may be stored on the client device and/or the chat and video conference provider. The chat and video conference provider may then publish the video message and/or the transcription to the chat channel, where it is available to one or more client devices, where each of the client devices is associated with a participant of the chat channel.

The client device may also generate a window prompting the user for privacy settings. The privacy settings may limit the video message to being viewable by a predetermined set of participants, and may include one or more sharing permissions. The sharing permissions may preclude a user from saving the video message on a client device after receiving the video message, sharing the message in a different chat channel, sharing the message on a social media platform, or other such permissions. In some embodiments, the client device has a set of stored privacy settings that are applied to each video message. The stored privacy settings may be set by a user, and administrator, an owner of the chat channel, or the chat and video conference provider. The stored privacy settings may be altered by the user, as allowed by an associated permission level.

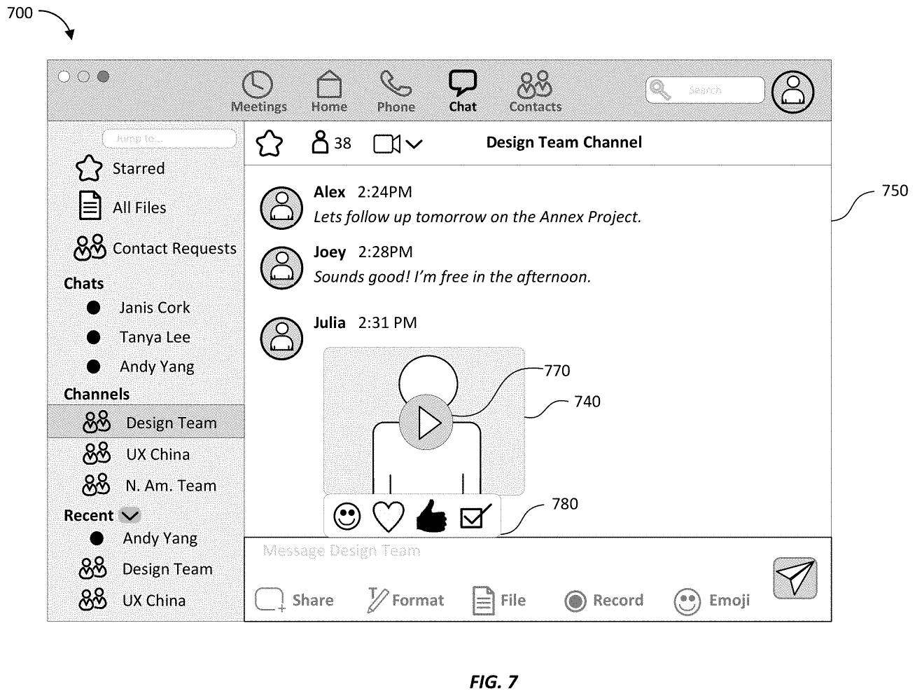

FIG. 7 shows a master chat panel 700 with a video message in a chat channel, according to certain examples. The master chat panel 700 may be similar to the master chat panel 600, and therefore have some or all of the same components and functionalities. The master chat panel 700 may be associated with a participant of the chat channel, separate from the user discussed in previous examples. The participant may be a viewer of a video message in the chat channel, instead of the sender, though any member of the channel may view the video message. Thus, the client device referred to in hereunder may be a different client device than the client device discussed above.

The client device may receive a video message 740 via a chat channel from the chat and video conference provider. The video message 740 may be the video message captured in the video message input window 540 in FIG. 5, and edited and sent through the video message editing window 640 in FIG. 6. The master chat panel 700 may display a chat window 750, including the video message 740. The video message 740 may be displayed in line with other messages posted in the chat channel. The other messages may include text-based chat, images, other video messages, and the like.

The video message 740 may include a play button 770. In some examples, the video message may automatically play upon being visible in the chat window 750 at the client device. In other examples, the video message 740 may not begin to play until a user command is received by the client device. The user command may correspond to the play button 770. The video message 740 may be played, replayed, paused or have other such operations performed by the client device. In effect, the client device may display the video message in the chat channel without a user being required to leave the chat channel to view the video. Similar functionality is provided for a demo as discussed above.

The client device may provide a translation option for the video message 740. The translation option may detect a first language of the video message 740, and prompt the client device for a second language. In response to a second language being selected, the client device may perform the translation. In some examples, the client may send a request to the chat and video conference provider to perform the translation service, or it may request the translation from a third party translation service. In some examples, the translation may be text that appears on the video message 740 (e.g., subtitles). In other examples, the translation may be an audio translation. In yet other examples, the translation may be an additional file, similar to a transcription, provided to the client device.

The master chat panel 700 may also provide functionality for the participant to react to the video message 740. For example, the chat window 750 may display a reaction bar 780 adjacent to the video message 740. In response to a user command, the client device may then send a reaction to the chat and video conference provider. The chat and video conference provider may then provide the reaction to one or more client devices via the chat channel. The reaction may be an image file (such as an emoji), an audio file, a video file, or any other electronic file.

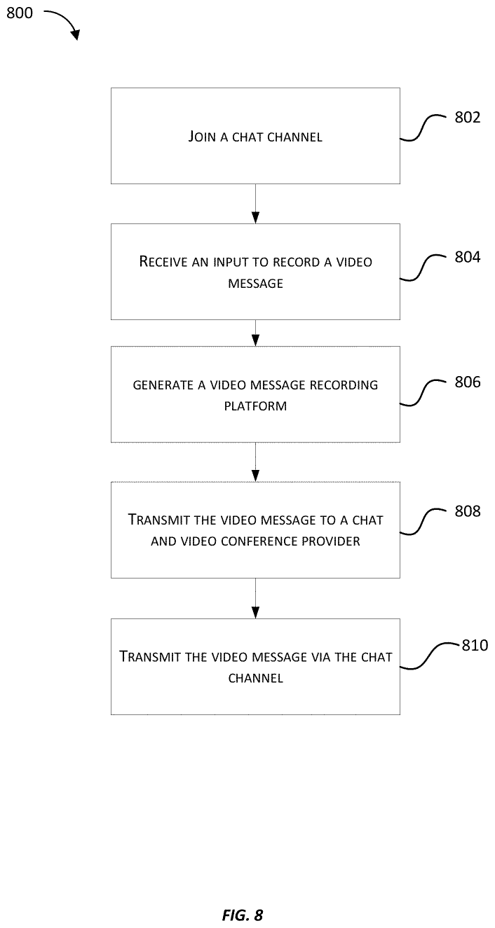

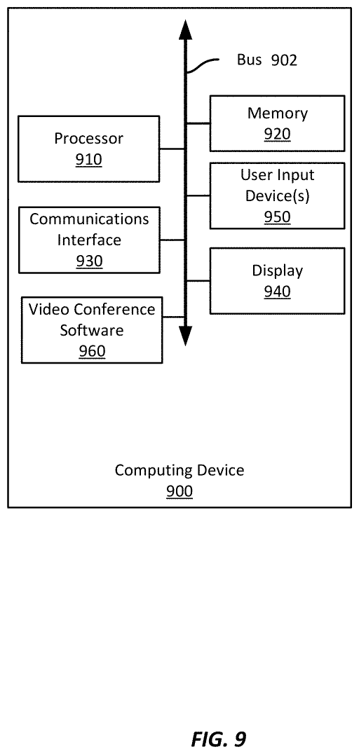

FIG. 8 shows a method of providing a video message within a chat channel, according to certain examples. The method 800 may be performed utilizing any of the systems disclosed herein, such as the system 100 in FIG. 1 and/or the system 200 in FIG. 2, and by a system such as that disclosed in FIG. 9. At 802, a first client device may join a chat channel, where one or more users may exchange messages via the chat channel. The one or more users may access the chat channel using respective client devices. In some examples, the chat channel may be established by a chat and video conference provider, as is described in relation to FIGS. 1 and 2. In some examples, more than one chat channels may be established. The chat channels may be displayed on the first client device in a master chat panel, such as the master chat panel 400 in FIG. 4.

At 804, the client device may receive an input to record a video message. The input may be a user input, corresponding to a button on a master chat panel, such as from the record button 520 in FIG. 5. At 806, the client device may generate a video message recording platform. The video message recording platform may be used to generate the video message. The video message recording platform may include a video message input window. The video message input window may be similar to the video message input window 540 in FIG. 5. The video message input window may be configured to cause the first client device to record audio and video data. In some examples, the audio and video data may include capturing video associated with a display of the first client device. The first client device may store the audio and video data as a video message in a memory device included in the first client device.

The video message recording platform may also include a video message editing window. The video message editing window may be similar to the video message editing window 640 in FIG. 6. The video message editing window may be configured to cause the first client device to modify the video message in accordance with user inputs. Modifying the video message may include adding a background to the video message, trimming the video message from a first image size to a second video size, where the second video size is smaller than the first image size, removing a portion of the video message, adding an effect to the video message, or performing any other such video editing operation. In some examples, the first client device may update the video message stored at the memory device included in the first client device.

At 808, the first client device may transmit the video message to the chat and video conference provider. The first client device may delete the video message from the included memory device after the video message is transmitted to the chat and video conference provider. In some examples, the chat and video conference provider may perform speech recognition on the video message. The speech recognition may be based on audio data recorded by the first client device and used to create a transcription of the video message. The chat and video conference provider may then provide the transcription of the video message to the plurality of client devices via the chat channel. In some examples, the transcription of the video message may be performed by the client device, then transmitted to the chat and video conference provider.

At 810, the chat and video conference provider may transmit an indication via the chat channel to the respective client devices that the video message has been posted to the chat channel. In some examples, a representation of the video message, such as a screenshot from the video message with the option to play the message, may be displayed with other messages in the chat channel on a client device associated with a participant of the chat channel. The video message may be played automatically by the client devices, or may be played only after receiving a request from the client device.

In some examples, the client device may provide functionality for the participant to react to the video message. For example, in relation to FIG. 7, the chat window 750 may display a reaction bar 780 adjacent to the video message 740. In response to a user command, the client device may then send a reaction to the chat and video conference provider. The chat and video conference provider may then provide the reaction to one or more client devices via the chat channel. The reaction may be an image file, an audio file, a video file, or any other electronic file.

In some examples, the client device may request a translation of the video message. The translation of the video message may be from a first language to a second language. The chat and service provider, in response to the request, may send information to the client device such that the client device generates a translation of the video message. In some examples, the chat and video conference provider generates the translation. In some examples, the translation may be text that appears on the video message (e.g., subtitles). In other examples, the translation may be an audio translation. In yet other examples, the translation may be an additional file, similar to the transcription, provided to the client device.

FIG. 9 shows an example computing device 900 suitable for use in example systems or methods for providing a video message in a chat channel, according to certain examples. The example computing device 900 includes a processor 910 which is in communication with the memory 920 and other components of the computing device 900 using one or more communications buses 902. The processor 910 is configured to execute processor-executable instructions stored in the memory 920 to perform one or more methods for providing a video message in a chat channel, such as part or all of the example method 900, described above with respect to FIG. 9. The computing device, in this example, also includes one or more user input devices 1050, such as a keyboard, mouse, touchscreen, video input device (e.g., one or more cameras), microphone, etc., to accept user input. The computing device 900 also includes a display 940 to provide visual output to a user.

The computing device 900 also includes a communications interface 930. In some examples, the communications interface 930 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification

As used below, any reference to a series of examples is to be understood as a reference to each of those examples disjunctively (e.g., “Examples 1-4” is to be understood as “Examples 1, 2, 3, or 4”).

Example 1 may be a system including a non-transitory computer-readable medium, a communications interface, and a processor communicatively coupled to the non-transitory computer-readable medium and the communication interface. The processor may be configured to execute processor executable instructions stored in the non-transitory computer-readable medium. The processor may join a chat channel, where the chat channel may be established by a chat and video conference provider and configured to enable one or more users to exchange messages using respective client devices. The processor may receive an input corresponding to a request to record a video message. The processor may generate a video message recording platform for generating the video message. The processor may transmit, to a chat and video conference provider, the video message generated on the video message recording platform. The processor may receive, from the chat and video conference provider via the chat channel, an indication that the video message may be posted in the chat channel.

Example 2 may be the system of any previous or subsequent example, where the processor executable instructions to generate the video message recording platform, further causes the processor to generate a video message input window, where the video message input window may be configured to record audio data and video data from the first client device.

Example 3 may be the system of any previous or subsequent example, where the processor executable instructions to generate the video message recording platform, further causes the processor to generate a video message editing window, where the video message editing window may be configured to modify the video message in accordance with a user input.

Example 4 may be the system of any previous or subsequent example, where modifying the video message includes at least one of adding a background to the video message. The processor may trimming the video message from a first image size to a second image size. The processor may or removing a segment of the video message.

Example 5 may be the system of any previous or subsequent example, where the video message may be limited to a predetermined time period.

Example 6 may be the system of any previous or subsequent example, where the processor executable instructions further causes the processor to perform speech recognition on the video message based on audio data recorded by the first client device, associated with the video message to create a transcription of the video message. The processor may transmit, to the plurality of client devices via the chat channel, the transcription of the video message.

Example 7 may be the system of any previous or subsequent example where the processor executable instructions to further cause the processor to translate a received video message from a first language to a second language.

Example 8 may be a method of providing a video message to a chat channel, the method including joining, by a first client device, a chat channel, where the chat channel may be established by a chat and video conference provider and configured to enable one or more users to exchange messages using respective client devices. The method may include receiving an input, corresponding to a request to record a video message. The method may include generating, by the first client device, a video message recording platform for generating the video message. The method may include transmitting, to a chat and video conference provider, the video message generated on the video message recording platform. The method may include and receiving, from the chat and video conference provider via the chat channel, an indication that the video message may be posted in the chat channel.

Example 9 may be the method of any previous or subsequent example, where generating a video message recording platform for generating the video message further includes generating a video message input window, where the video message input window may be configured to cause the first client device to record audio and video data.

Example 10 may be the method of any previous or subsequent example, where recording audio and video data further includes capturing video associated with a display of the first client device.

Example 11 may be the method of any previous or subsequent example, where generating, by the first client device, a video message recording platform for generating the video message further includes generating, by the first client device, a video message editing window, where the video message editing window may be configured to modify the video message in accordance with user inputs.

Example 12 may be the method of any previous or subsequent example, where modifying the video message includes at least one of adding a background to the video message. The method may include trimming the video message from a first image size to a second image size. The method may include or removing a segment of the video message.

Example 13 may be the method of any previous or subsequent example, further including receiving, from the chat and video conference provider, a response to the video message associated with a second client device via the chat channel. The method may include and displaying, on the first client device, the response to the video message.

Example 14 may be a non-transitory computer-readable medium including processor-executable instructions configured to cause one or more processors to join, by a first client device, a chat channel, where the chat channel may be established by a chat and video conference provider and configured to enable one or more users to exchange messages using respective client devices. The one or more processors may also receive an input, corresponding to a request to record a video message. The one or more processors may also generate, by the first client device, a video message recording platform for generating the video message. The one or more processors may also transmit, to a chat and video conference provider, the video message generated on the video message recording platform. The one or more processors may also receive, from the chat and video conference provider via the chat channel, an indication that the video message may be posted in the chat channel.

Example 15 may be the non-transitory computer-readable medium of any previous or subsequent example including processor-executable instructions, the processors further configured to generate a video message input window, where the video message input window may be configured to record audio data and video data from the first client device.

Example 16 may be the non-transitory computer-readable medium of any previous or subsequent example including processor-executable instructions, the processors further configured to generate a video message editing window, where the video message editing window may be configured to modify the video message in accordance with user inputs.

Example 17 may be the non-transitory computer-readable medium of any previous or subsequent example including processor-executable instructions, the processors further configured to perform speech recognition on the video message based on audio data recorded by the first client device and associated with the video message to create a transcription of the video message. The one or more processors may also transmit, to the plurality of client devices via the chat channel, the transcription of the video message.

Example 18 may be the non-transitory computer-readable medium of any previous or subsequent example including processor-executable instructions, the processors further configured to translate a received video message from a first language to a second language.

Example 19 may be the non-transitory computer-readable medium of any previous or subsequent example including processor-executable instructions, where the video message may be limited to a predetermined time period.

Example 20 may be the non-transitory computer-readable medium of any previous or subsequent example including processor-executable instructions, where the video message may be limited to a predetermined file size.

1. A system comprising:
a non-transitory computer-readable medium;
a communications interface; and
a processor communicatively coupled to the non-transitory computer-readable medium and the communication interface, the processor configured to execute processor executable instructions stored in the non-transitory computer-readable medium to:
access, using a user account, a chat and video conference provider, the chat and video conference provider maintaining a plurality of persistent chat channels configured to be accessible by one or more users to exchange messages using respective client devices;
receive a selection of a first persistent chat channel of the plurality of persistent chat channels, the user account authorized to access the first persistent chat channel;
receive an input corresponding to a request to record a video message for the first persistent chat channel;
record the video message;
transmit, to the chat and video conference provider, the video message; and
receive, from the chat and video conference provider via the first persistent chat channel, an indication that the video message is posted in the first persistent chat channel.

2. The system of claim 1, wherein the processor is configured to execute further processor executable instructions to:
generate a video message input window, wherein the video message input window is configured to record audio data and video data from a first client device.

3. The system of claim 1, wherein the processor is configured to execute further processor executable instructions to:
generate a video message editing window, wherein the video message editing window is configured to modify the video message in accordance with a user input.

4. The system of claim 3, wherein modifying the video message comprises at least one of:
adding a background to the video message;
trimming the video message from a first image size to a second image size; or
removing a segment of the video message.

5. The system of claim 1, wherein the video message is limited to a predetermined time period.

6. The system of claim 1, wherein the processor is configured to execute further processor executable instructions to:
perform speech recognition on the video message based on audio data recorded by a first client device, associated with the video message to create a transcription of the video message; and
transmit, to a plurality of client devices via the first persistent chat channel, the transcription of the video message.

7. The system of claim 1 wherein the processor is configured to execute further processor executable instructions to:
translate a received video message from a first language to a second language.

8. A method of providing a video message to a chat channel, the method comprising:
accessing, by a first client device using a user account, a chat and video conference provider, the chat and video conference provider maintaining a plurality of persistent chat channels configured to be accessible by one or more users to exchange messages using respective client devices;
receiving a selection of, by the first client device, a first persistent chat channel of the plurality of persistent chat channels, the user account authorized to access the first persistent chat channel;
recording, by the first client device, the video message
transmitting, to the chat and video conference provider, the video message; and
receiving, from the chat and video conference provider via the first persistent chat channel, an indication that the video message is posted in the first persistent chat channel.

9. The method of claim 8, further comprising:
generating a video message input window, wherein the video message input window is configured to cause the first client device to record audio and video data.

10. The method of claim 9, wherein recording audio and video data further comprises:
capturing video associated with a display of the first client device.

11. The method of claim 8, further comprising:
generating, by the first client device, a video message editing window, wherein the video message editing window is configured to modify the video message in accordance with user inputs.

12. The method of claim 11, wherein modifying the video message comprises at least one of:
adding a background to the video message;
trimming the video message from a first image size to a second image size; or
removing a segment of the video message.

13. The method of claim 8, further comprising:
receiving, from the chat and video conference provider, a response to the video message associated with a second client device via the first persistent chat channel; and
displaying, on the first client device, the response to the video message.

14. A non-transitory computer-readable medium comprising processor-executable instructions configured to cause one or more processors to:
access, by a first client device using a user account, a chat and video conference provider, the chat and video conference provider maintaining a plurality of persistent chat channels configured to be accessible by one or more users to exchange messages using respective client devices;
receive a selection, by the first client device, of a first persistent chat channel of the plurality of persistent chat channels, the user account authorized to access the first persistent chat channel;
receive an input corresponding to a request to record a video message for the first persistent chat channel;
record the, by the first client device, video message;
transmit, to the chat and video conference provider, the video message; and
receive, from the chat and video conference provider via the first persistent chat channel, an indication that the video message is posted in the first persistent chat channel.

15. The non-transitory computer-readable medium of claim 14 comprising processor-executable instructions, the processors further configured to:
generate a video message input window, wherein the video message input window is configured to record audio data and video data from the first client device.

16. The non-transitory computer-readable medium of claim 14 comprising processor-executable instructions, the processors further configured to:
generate a video message editing window, wherein the video message editing window is configured to modify the video message in accordance with user inputs.

17. The non-transitory computer-readable medium of claim 14 comprising processor-executable instructions, the processors further configured to:
perform speech recognition on the video message based on audio data recorded by the first client device and associated with the video message to create a transcription of the video message; and
transmit, to a plurality of client devices via the first persistent chat channel, the transcription of the video message.

18. The non-transitory computer-readable medium of claim 14 comprising processor-executable instructions, the processors further configured to:
translate a received video message from a first language to a second language.

19. The non-transitory computer-readable medium of claim 14 comprising processor-executable instructions, wherein the video message is limited to a predetermined time period.

20. The non-transitory computer-readable medium of claim 14 comprising processor-executable instructions, wherein the video message is limited to a predetermined file size.
